(19) United States
(12) Patent Application Publication
(10) Pub. No.: US 2008/0285227 A1
(43) Pub. Date: Nov. 20, 2008

(54) Modular small size computer system

(76) Inventors: Lindsey E. Kennard, Lexington, MA (US); Wayne M. Kennard, Lexington, MA (US)

Correspondence Address: Wayne M. Kennard, 28 Partridge Road, Lexington, MA, 02421, US

(21) Appl. No.: 11/803,299

(22) Filed: May 14, 2007

(51) Int. Cl. G06F 1/16; G09G 5/00

(52) U.S. Cl. 361/686; 345/169; 345/8

(57) ABSTRACT

A modular small size computer system is disclosed that may be used in a very limited workspace environment in the close proximity of other people without the ability of such people being able to view the information on the display screen. The modular small size computer system includes four main elements: a nano-processor unit, a power supply, visual display goggles for projecting a virtual display screen, a mouse/input device, and a keyboard. The modular small size computer system may be a stand-alone system or configured to attach to the laptop, tablet notebook, or desktop computer that will serve as the primary computer.

### FIELD OF THE INVENTION

The present invention relates to portable personal computing systems that are used in areas where there is minimal space to use a computer. More specifically, the present invention relates to portable personal computing systems that are used win areas with minimal space, such as on an airplane, and provide security in their use.

### BACKGROUND OF THE INVENTION

If you are a frequent traveler on airplane, trains, automobiles, or the like, and you are a computer user, there can be great frustration when you seek to use a laptop or notebook computer. Unless you are in first class, and sometimes that is not enough, there is no room to open the laptop or notebook computer, and do your work. This is exacerbated in an airplane when the passenger seated in front of you chooses to recline the seat. This effectively creates a situation where it is next to impossible to use your computer.

There have been two principal solutions to this problem. The first is simply to use devices that are smaller, such as a personal digital assistant or a Blackberry®¹. This is fine but it also means the display screen is smaller and the user must suffer the use of keyboards that are smaller with smaller keys that can cause inaccurate typing. Moreover, such systems do not provide all of the functionality of a laptop or notebook computer. Thus, they are not in reality an adequate substitute. ¹ Blackberry® is a registered trademark of Research in Motion Limited.

The second solution is the tablet notebook. These systems permit the user to configure the computer so that it sits flat like a tablet that can be written on in longhand. Many tablet notebooks have software that will convert the written text to typed text. This feature makes the use of the tablet computer viable.

There is another problem that may arise when a computer is used in a crowded area or in close proximity with other people. In these situations, people can visually eavesdrop on the information on your display screen. This may be a problem because in many cases the information on the display screen is confidential or proprietary information. A proposed solution has been the development of special filter for screens that are placed over them to prevent people viewing your display screen if they are disposed at an angle to the display screen. However, this solution has little effect on someone who is sitting behind you.

There needs to be a small, portable, robust system that is available to solve the above indicated problems.

### SUMMARY OF THE INVENTION

The present invention is a modular small size computer system that may be used in a very limited workspace environment in the close proximity of other people without the ability of such people being able to view the information on the display screen. The present invention also may be used in locations, such as airplanes, without the detrimental effects of the past.

The modular small size computer system includes at a minimum four connected elements. The first is the nano-processor unit, which is approximately the size of a 40 GB iPod®² or a little larger. This is the main element of the system. The nano-processor unit is capable of being connected to a laptop, tablet notebook, or desktop computer for downloading and uploading data that is to be worked on by the user or has been worked on by the user, respectively. ² IPod is a registered trademark of Apple, Inc.

The nano-processor unit includes an integrated motherboard with a central processing unit (CPU) having an appropriate processing speed, random access memory (RAM), read-only memory (ROM), appropriate firmware, and a cooling system. The nano-processor unit includes a plurality of connectors for connecting internal electronics structure of the nano-processor unit to the other system components and other computers, such as a desktop, tablet notebook, or laptop computer, and to auxiliary equipment, such as printers and external storage devices.

The second element is a display screen that is in the form of visual display goggles that project a virtual visual display in front of the user. This virtual display screen may appear four feet away. The goggles may also be equipped to provide audio to the user.

The third element of the system is a keyboard. It may be flexible so it will adapt to any surface that a traveler may encounter.

The fourth element of the system is a power source that may be in the form of a battery or battery pack. The power source may also be a power connection that is provided in airplanes and trains.

In a first embodiment of the system of the present invention, it may be a stand-alone system operating with a standard operation system. In a second embodiment, it may be a limited auxiliary system that would operate using an operating system but would download a limited amount of information or data from a primary computer, such as a desktop, tablet notebook, or laptop computer, to work on for a period of time he or she is in a limited workspace environment. Once that work was completed, it would be uploaded to the laptop, tablet notebook, or desktop computer, or downloaded to a peripheral device, such as a printer or an external storage device.

With respect to either of the embodiments, the user will be able work comfortably in the limited workspace environment and also work securely even if someone is in very close proximity. This provides increased security so that confidential and proprietary information is not inadvertently divulged to people who are near the user.

An object of the present invention is to provide a modular small size computer system that will provide a user the ability to use a computer in a very limited space environment.

Another object of the present invention is to provide a modular small size computer system that will provide a user the ability to use a computer securely in a very limited workspace environment with people in close proximity.

These and other objects will be explained in detail in the remainder of the specification referring to the attached drawings.

### BRIEF DESCRIPTION OF THE DRAWINGS

FIG. 1 is a perspective view of an embodiment of the modular small size computer system of the present invention.

FIG. 2 is a perspective view of the nano-processor of the modular small size computer system of the present invention.

FIG. 3 is a view of the visual display goggles and the projection of the virtual visual display according to the present invention.

FIG. 4 is a view of the virtual visual display that will appear to the user when using the system of the present invention.

### DETAILED DESCRIPTION OF THE INVENTION

The present invention is a modular small size computer system that provides the user with the ability of the work comfortably in a small workspace environment. Moreover, the modular small size computer system of the present invention also provides a secure environment in which the user may work in a small workspace environment.

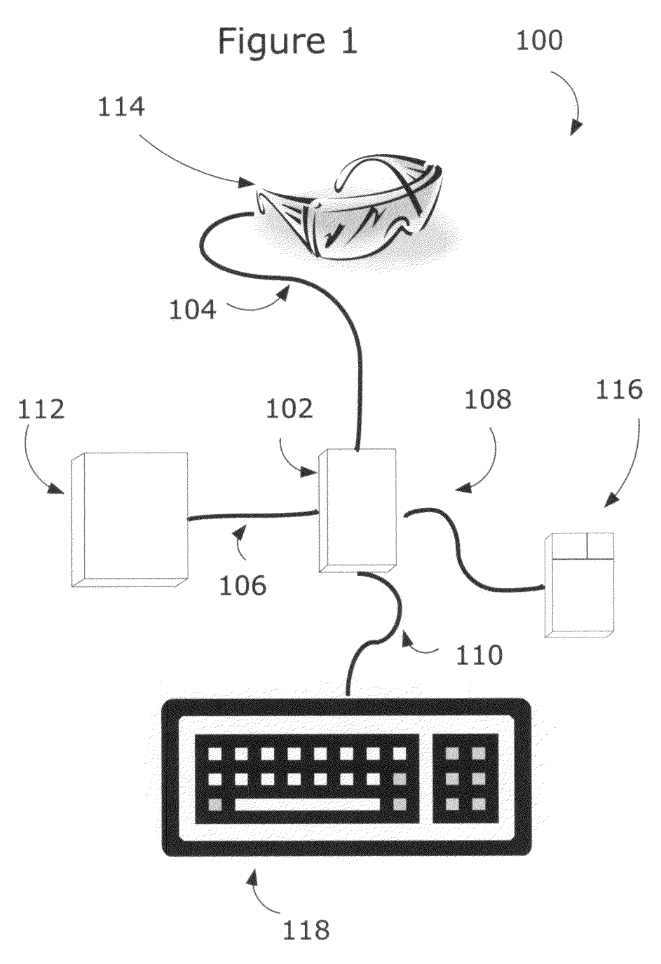

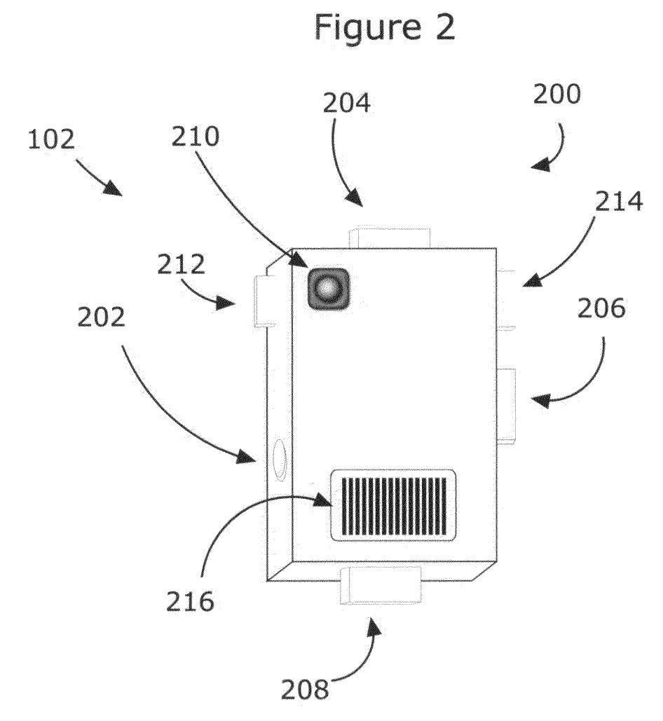

Referring to FIG. 1 generally at 100, an embodiment of the present invention is shown. The system of the present invention includes four main elements. These are nano-processor unit 102, power supply 112, display goggles 114, mouse/input unit 116, and keyboard 118. Nano-processor unit 102 will be described in greater detail with regard to FIG. 2.

Again referring to FIG. 1, nano-processor unit 102 will include a motherboard with at least a CPU, RAM, ROM, appropriate firmware, and the ability to connect the other system components, peripherals, and other computers, and a cooling system The RAM and ROM will be sufficient for the nano-processor unit to operate as a stand-alone computer. As such, the nano-processor unit will have a full or partial operating system loaded on it so that it is compatible with standard operating systems such as Microsoft Windows®, Microsoft Vista®, or Linux®.³ Further, it is contemplated that modified versions of standard operating systems may be provided to accommodate the amount of storage space available on the nano-processor unit. These custom operating systems may be developed by the present developers of the operating systems or by others. ³ as Microsoft Windows®, and Microsoft Vista® are registered trademarks of Microsoft Corp. and Linux® is a registered trademark of Linus Torvalds, an individual.

Power supply 112 is connected to nano-processor unit 102 by line 106. The power supply may be in the form of a battery or battery pack. Power supply 112 may also be adaptable for connecting to mobile power output units in cars, trains, and airplanes. It is contemplated that the power supply may be connected to nano-processor unit 102 by line 106 or the system of the present invention may be configured such that the power supply and nano-processor unit are directly connected.

Input device 116 is for the user to control operation of the system if such user does not use the special keys of keyboard 118 for this purpose. Input device 116 is connected to nano-processor unit 102 via line 108. It may be a mouse that has conventional operating functions for controlling nano-processor unit 102. Although, input device 116 is shown hardwired to nano-processor unit 102, it also may be connected wirelessly and still be within the scope of the present invention.

Keyboard 118 is connected nano-processor unit 102 by line 110. The keyboard may be a conventionally sized keyboard or smaller but in the latter case, the keys are substantially standard sized. Moreover, the keyboard may be flexible to adapt the surface that user has available for use. As stated, keyboard 118 is connected to nano-processor unit by line 110, which means it is hardwired to the nano-processor unit. It is understood that keyboard 118 may be a wireless keyboard and still be within the scope of the present invention.

The final main element of the system of the present invention is visual display goggles 114. The display goggles are connected to nano-processor unit 102 by line 104. The display goggles project a virtual display screen for the system of the present invention. The projected display screen may appear to be four feet away. The goggles when worn by the user provide the same or similar experience as if the user is viewing a large computer display screen of a laptop or flat screen display.

The goggles may be equipped with one or two audio reproduction devices such as earphones or ear buds to provide audio to the user when using the system of the present invention. Nano-processor unit 102 will provide the audio information to the goggles via line 104 along with the other data and power.

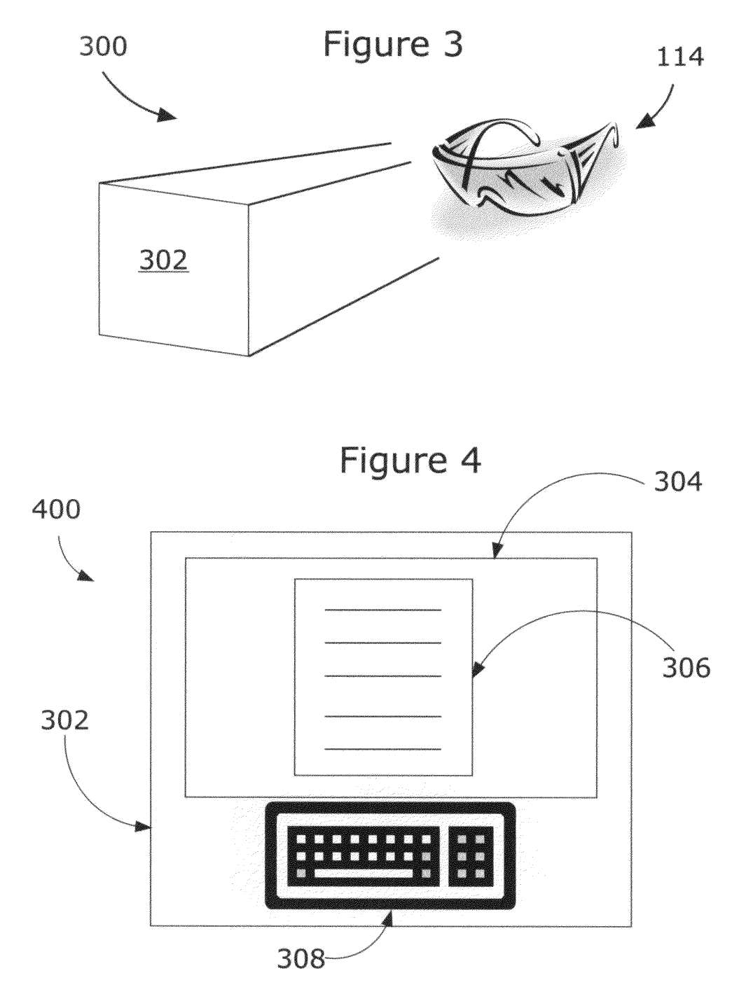

If the visual display goggles are powered separately, they may be connected wirelessly to nano-processor unit 102, for example, using Bluetooth technology or other wireless technology. The display that is presented by using the visual display goggles will be described in greater detail with regard to FIGS. 3 and 4.

Line 104 that connects goggles 114 to nano-processor unit 102 may provide both power and data to the goggles from the nano-processor unit. The system of the present invention also contemplates that the goggles may have an independent connection to a power source via a line not shown. If this separate power source is used, only data will be transmitted between the nano-processor unit 102 and display screen goggles 114.

Referring to FIG. 2 generally at 200, nano-processor unit 102 will be described in greater detail. Nano-processor unit 102 has a very small size due to nano-technology. Because of this, the nano-processor unit may have a significant amount of the functionality of a laptop or tablet notebook computers. Nano-processor unit 102 has power supply plug in 202. This plug in receives the terminal connector at the end of line 106 to supply power to nano-processor unit 102 and may, in some circumstances, supply power to other system elements connected to the nano-processor unit.

Connector 204 of nano-processor unit 102 is used to connect to one of the ends of line 104. The other end of line 104 connects to visual display goggles 114. Connector 204 will have the appropriate configuration for connecting to line 104 so that data and power may be transmitted between the nano-processor unit and display screen goggles. 114. For example, the connector may be a USB, USB2, 9-pin connector, or other type of connector and still be within the scope of the present invention.

Connector 206 of nano-processor unit 102 is used to connect to one of the ends of line 108. The other end of line 108 connects to input device 116. Typically, connector 206 may be a USB or USB2 connector. Connector 206 may be used for power and data transfer between nano-processor unit 102 and input device 116. If input device 116 is separately powered, for example, with AA or AAA battery(ies), there may be a wireless connection between the input device and the nano-processor unit if both the input device and nano-processor unit are configured, for example, with Bluetooth wireless technology or other wireless technology.

Connector 208 of nano-processor unit 102 is used to connect to one of the ends of line 110. The other end of line 110 connects to nano-processor unit 102. Typically, connector 208 may be a USB or USB2 connector. Connector 208 may be used for the transmission of power and data between nano-processor unit 102 and keyboard 118. If keyboard 118 is separately powered, for example, with AA or AAA battery(ies), there may be a wireless connection between the keyboard and the nano-processor unit if both the keyboard and nano-processor unit are configured, for example, with Bluetooth wireless technology or other wireless technology.

Connector 212 is for connection to peripheral devices, such as printers or external storage devices. Typically, connector 212 may be a USB or USB2 connector or other appropriate connector for connection to a particular peripheral. If the peripheral is separately powered, there may be a wireless connection between the nano-processor unit and the peripheral if both the peripheral and nano-processor unit are configured, for example, with Bluetooth wireless technology or other wireless technology.

Connector 214 is for connection to user's primary computer for the exchange of data between the system of the present invention and the primary computer. This connection may be a hardwired or wireless connection. The latter being effected if the both the nano-processor unit and the primary computer are configured, for example, with Bluetooth wireless technology or other wireless technology.

Button 210 is for manually turning nano-processor unit 102 on and off. This button may be used in conjunction with the software methods of the operating system for controlling the system, namely, “Shut-Down,: “Standby,” “Log-off,” “Restart,” and “Hibernate.” Button 210 operates in a conventional manner.

Vent 216 is disposed in nano-processor unit 102 for exhausting heat from within the nano-processor unit. A cooling system within the nano-processor unit will remove the heat generated, for example, by the CPU. Without heat removal, the system would overheat and fail. The cooling system may consist, for example, of heat sinks and small mechanical fans or a liquid cooling system. The heat removed by the cooling system is vented from the nano-processor unit through vent 216. Although only vent 216 is shown, it is understood there may be additional heat removal vents and still be within the scope of the present invention. Further, the cooling system may be configured differently and still be within the scope of the present invention.

FIGS. 3 and 4 will be used to describe the visual display goggles of the present invention. Referring to FIG. 3 generally at 300 the virtual projection of display screen 302 is shown. The size of the display screen 302 is adjustable to the desires of the user. Typically, the screen will be projected 2-4 feet from goggles 114.

Referring now to FIG. 4 generally at 400, a representative display screen 302 is shown. Display screen 302 has a representative keyboard 308 at the bottom. Virtual keyboard 308 will provide a typing reference for the user because many users are not perfect touch typists. When the user strikes a key on the actual keyboard (see FIG. 1), it will cause the same key to be illuminated on virtual keyboard 308. Further, if the user does not know the location of all of the keys, he or she will have a reference without looking at the actual keyboard, which in some cases could not be easily seen, for example, on an airplane when the passenger in front of you reclines the seat.

The actual screen portion of display screen 302 is shown at 304. Screen portion 304 is akin to the display screen of a laptop or notebook computer, or flat screen display of a desktop computer. For purposes of illustration, text document 306 is shown. This may be a document that the user is working on in a limited workspace environment. This document could be one that was initially created by the system of the present invention. However, document 306 could be a document that was downloaded from the primary computer (not shown) via connector 214 of nano-processor unit 102 (FIG. 1). After the document is worked on it may be uploaded to the primary computer. The completed document could also be transmitted to a peripheral device, such as a printer or external storage device, via connector 212 (FIG. 1).

The system of the present invention may be configured in at least two embodiments. In the first embodiment, nano-processor unit 102 is configured as shown in FIG. 2 with the connectors as shown. According the first embodiment, the system of the present invention is configured to use all of the connectors in operation.

According to the second embodiment of the present invention, nano-processor unit 102 is not configured to use all of the connectors in the same way as the first embodiment because the second embodiment is a stand-alone system. In the second embodiment, its operation is not dependent on an information exchange between the primary computer and nano-processor unit 102 of the present invention. Other than these differences, the first and second embodiments operate the same or similar with respect to input device 116, keyboard 118, power supply 112, and visual display goggles 114.

The terms and expressions that are used herein are meant for description not limitation. It being recognized that there may be minor changes or modifications that must take place and be within the scope of the present invention.

1. A stand-alone modular computer system for use in a limited workspace environment, comprising:
(a) nano-processor for controlling operation of the system with the nano-processor having a size sufficiently small that it may be used in the limited workspace environment, with nano-processor including at least
(1) a motherboard have disposed thereon at least a central processing unit (CPU), random access memory (RAM), read only memory (ROM), with the CPU being programmed to operate according to an operating system stored at least in part in the RAM and ROM,
(2) a plurality of connectors for connecting the system components,
(3) a cooling system for removing heat from within the nano-processor;
(b) a power supply that is connected to the nano-processor through one of the plurality of connectors, with the power supply for providing power to the nano-processor;
(c) an input device that is connected to the nano-processor through one of the plurality of connectors, with the input device for controlling at least in part the operation of the system;
(d) a keyboard that is connected to the nano-processor through one of the plurality of connectors, with the keyboard for providing inputs to the system for controlling in part the operation of the system; and
(e) visual display goggles that are connected to the nano-processor through one of the plurality of connectors, with the visual display goggles for projecting a visual display readable only by the user, with the visual display including at least
(1) a section for displaying a representation of the keyboard and contrasting keyboard elements as each is activated by the user, and
(2) a section for displaying items being at least created, edited, or processed by the user.

2. The system as recited in claim 1, wherein the nano-processor has at least one vent for exhausting heat from within the nano-processor removed by the cooling system.

3. The system as recited in claim 1, wherein the keyboard is a flexible keyboard.

4. The system as recited in claim 1, wherein the visual display goggles are capable of providing an audio output to the user.

5. The system as recited in claim 1, wherein the keyboard elements include keys and contrasting the keyboard elements includes illuminating the keys differently on the visual display when such keys are activated on the keyboard by the user.

6. The system as recited in claim 1, wherein the nano-processor includes at least one connector for connecting to peripheral devices.

7. The system as recited in claim 6, wherein the peripheral devices include a printer.

8. The system as recited in claim 6, wherein the peripheral devices include an external storage device.

9. A stand-alone modular computer system for use in a limited workspace environment, comprising:
(a) nano-processor for controlling operation of the system with the nano-processor having a size sufficiently small that it may be used in the limited workspace environment, with nano-processor including at least
(1) a motherboard have disposed thereon at least a central processing unit (CPU), random access memory (RAM), read only memory (ROM), with the CPU being programmed to operate according to an operating system stored at least in part in the RAM and ROM,
(2) a plurality of hardwire connectors for connecting the system components,
(3) wireless connection capability,
(4) a cooling system for removing heat from within the nano-processor;
(b) a power supply that is connected to the nano-processor through one of the plurality of connectors, with the power supply for providing power to the nano-processor;
(c) an input device that is connected to the nano-processor through one of the plurality of connectors or wirelessly, with the input device for controlling at least in part the operation of the system;
(d) a keyboard that is connected to the nano-processor through one of the plurality of connectors or wirelessly, with the keyboard for providing inputs to the system for controlling in part the operation of the system; and
(e) visual display goggles that are connected to the nano-processor through one of the plurality of connectors or wirelessly, with the visual display goggles for projecting a visual display readable only by the user, with the visual display including at least
(1) a section for displaying a representation of the keyboard and contrasting keyboard elements as each is activated by the user, and
(2) a section for displaying items being at least created, edited, or processed by the user.

10. The system as recited in claim 9, wherein the nano-processor has at least one vent for exhausting heat from within the nano-processor removed by the cooling system.

11. The system as recited in claim 9, wherein the keyboard is a flexible keyboard.

12. The system as recited in claim 9, wherein the visual display goggles are capable of providing an audio output to the user.

13. The system as recited in claim 9, wherein the keyboard elements include keys and contrasting the keyboard elements includes illuminating the keys differently on the visual display when such keys are activated on the keyboard by the user.

14. The system as recited in claim 9, wherein the nano-processor includes at least one connector for connecting to peripheral devices.

15. The system as recited in claim 14, wherein the peripheral devices include a printer.

16. The system as recited in claim 14, wherein the peripheral devices include an external storage device.

17. A auxiliary modular computer system for use in a limited workspace environment, comprising:
(a) nano-processor for controlling operation of the system with the nano-processor having a size sufficiently small that it may be used in the limited workspace environment, with nano-processor including at least
(1) a motherboard have disposed thereon at least a central processing unit (CPU), random access memory (RAM), read only memory (ROM), with the CPU being programmed to operate according to an operating system stored at least in part in the RAM and ROM,
(2) a plurality of connectors for connecting the system components,
(3) a connector for connecting to a primary computer for transmission of data between the nano-processor and the primary computer,
(4) a cooling system for removing heat from within the nano-processor;
(b) a power supply that is connected to the nano-processor through one of the plurality of connectors, with the power supply for providing power to the nano-processor;
(c) an input device that is connected to the nano-processor through one of the plurality of connectors, with the input device for controlling at least in part the operation of the system;
(d) a keyboard that is connected to the nano-processor through one of the plurality of connectors, with the keyboard for providing inputs to the system for controlling in part the operation of the system; and
(e) visual display goggles that are connected to the nano-processor through one of the plurality of connectors, with the visual display goggles for projecting a visual display readable only by the user, with the visual display including at least
(1) a section for displaying a representation of the keyboard and contrasting keyboard elements as each is activated by the user, and
(2) a section for displaying items being at least created, edited, or processed by the user.

18. The system as recited in claim 17, wherein the nano-processor has at least one vent for exhausting heat from within the nano-processor removed by the cooling system.

19. The system as recited in claim 17, wherein the keyboard is a flexible keyboard.

20. The system as recited in claim 17, wherein the visual display goggles are capable of providing an audio output to the user.

21. The system as recited in claim 17, wherein the keyboard elements include keys and contrasting the keyboard elements includes illuminating the keys differently when such key is activated on the keyboard by the user.

22. The system as recited in claim 17, wherein the nano-processor includes at least one connector for connecting to peripheral devices.

23. The system as recited in claim 22, wherein the peripheral devices include a printer.

24. The system as recited in claim 22, wherein the peripheral devices include an external storage device.

25. The system as recited in claim 17, wherein the primary computer is a laptop computer.

26. The system as recited in claim 17, wherein the primary computer is a desktop computer.

27. A auxiliary modular computer system for use in a limited workspace environment, comprising:
(a) nano-processor for controlling operation of the system with the nano-processor having a size sufficiently small that it may be used in the limited workspace environment, with nano-processor including at least
(1) a motherboard have disposed thereon at least a central processing unit (CPU), random access memory (RAM), read only memory (ROM), with the CPU being programmed to operate according to an operating system stored at least in part in the RAM and ROM,
(2) a plurality of connectors for connecting the system components,
(3) a connector for connecting to a primary computer for transmission of data between the nano-processor and the primary computer,
(4) wireless connection capability,
(5) a cooling system for removing heat from within the nano-processor;
(b) a power supply that is connected to the nano-processor through one of the plurality of connectors, with the power supply for providing power to the nano-processor;
(c) an input device that is connected to the nano-processor through one of the plurality of connectors or wirelessly, with the input device for controlling at least in part the operation of the system;
(d) a keyboard that is connected to the nano-processor through one of the plurality of connectors or wirelessly, with the keyboard for providing inputs to the system for controlling in part the operation of the system; and
(e) visual display goggles that are connected to the nano-processor through one of the plurality of connectors or wirelessly, with the visual display goggles for projecting a visual display readable only by the user, with the visual display including at least
(1) a section for displaying a representation of the keyboard and contrasting keyboard elements as each is activated by the user, and
(2) a section for displaying items being at least created, edited, or processed by the user.

28. The system as recited in claim 27, wherein the nano-processor has at least one vent for exhausting heat from within the nano-processor removed by the cooling system.

29. The system as recited in claim 27, wherein the keyboard is a flexible keyboard.

30. The system as recited in claim 27, wherein the visual display goggles are capable of providing an audio output to the user.

31. The system as recited in claim 27, wherein the keyboard elements include keys and contrasting the keyboard elements includes illuminating the keys differently when such key is activated on the keyboard by the user.

32. The system as recited in claim 27, wherein the nano-processor includes at least one connector for connecting to peripheral devices.

33. The system as recited in claim 32, wherein the peripheral devices include a printer.

34. The system as recited in claim 32, wherein the peripheral devices include an external storage device.

35. The system as recited in claim 27, wherein the primary computer is a laptop computer.

36. The system as recited in claim 27, wherein the primary computer is a desktop computer.

37. The system as recited in claim 27, wherein the connection between the nano-processor and the primary computer may be a wireless connection.
